(19) United States
(12) Patent Application Publication
(10) Pub. No.: US 2007/0012133 A1
(43) Pub. Date: Jan. 18, 2007

(54) Rollign screw with smaller advance per turn than the pitch of the threading

(76) Inventor: Giancarlo Brun, Thiene (IT)

Correspondence Address: BIRCH STEWART KOLASCH & BIRCH, PO BOX 747, FALLS CHURCH, VA, 22040-0747, US

(21) Appl. No.: 10/561,440

(22) PCT Filed: May 25, 2004
(86) PCT No.: PCT/EP04/05595

§ 371 Date: Dec. 20, 2005

(30) Foreign Application Priority Data
Jun. 23, 2003 (IT) VI2003A000119

(51) Int. Cl. F16H 1/24

(52) U.S. Cl. 74/424.75

(57) ABSTRACT

This invention concerns a rolling screw with smaller advance per turn than the pitch of the threading, characterised in that a threaded coupling is foreseen in which a screw (1) is turned inside one or more female screws inserted in a single body or sleeve (2) and where the pitch of the thread of said female screws is equal to that of the screw (1), whereas the nominal diameter is greater than that of the screw itself.

The present finding concerns a rolling screw that has application in the mechanical field, when it is necessary to move loads by applying a torque of forces of limited value.

Known in the current state of the art are:
sliding screws: normally used in so-called “screw jacks”, which have the drawback of a low yield due to the substantial sliding friction which develops between the threaded surfaces of the screw and of the female screw, in a mutual sliding position; with such a type of threaded coupling the axial advance of the screw for every turn is equal to the length of the pitch of the thread;
rolling screws: are characterised by a high yield since the friction present in such types of coupling is of the rolling type, obtained with the use of bodies placed between screw and female screw configured with rollers or balls; thanks to the high yields such screws are reversible and can be divided into three types:
ball screws, where the axial advance per turn is equal to the pitch of the threading and the torque used is substantially proportional to the load and to the ratio between the pitch and the nominal circumference of the threading of the screw.
threaded planetary roller screws, where the advance per turn is dependent upon the pitch of the thread, the ratio between the pitch diameter of the screw and the pitch diameter of the planetary roller and the direction of rotation of the threading of the screw and of the planetary roller. Such types of screws hare applied when high load capacities associated with high translation speeds are required, made possible with the use of planetary rollers with a substantially smaller diameter with respect to the diameter of the screw (the advance per turn of the screw is greater than the pitch of the thread and for this reason they are also reversible) and the torque used is substantially proportional to the load and to the ratio between the advance and the pitch rolling circumference of the screw on the rollers;
roller screws, where the axial advance is equal to the pitch of the thread, the load capacity is very high, but the rotation speed is of limited value; the torque used is substantially proportional to the load and to the ratio between the pitch and the pitch rolling circumference of the screw on the rollers.

The purpose of the present finding is that of realising a rolling screw that does not have the drawbacks of similar known products; in particular, it must be able to move loads of substantial size, with the application of a torque of minimal value, it must have a high number of turns and be an irreversible system.

A further purpose of the present finding is that of realising a mechanism, with the functional characteristics of the main purpose, which is constructively simple and cost-effective.

A further purpose of the present finding is that of realising products and machines, such as mechanical screw jacks, linear actuation units and the like, which use the rolling screw of the type described in the main purpose.

The main purpose is accomplished, in accordance with claim 1, with a threaded coupling in which a screw is made to turn inside one or more female screws (inserted in a single body or sleeve) and where the pitch of the thread of said female screws is equal to that of the screw, whereas the nominal diameter is greater than that of the screw itself.

In a first embodiment the female screws, all having the same nominal diameter, each consist of a bearing, of the type that is able to simultaneously bear both radial and axial loads, consisting of an inner ring that has the inner hole threaded.

In a second embodiment, the threaded inner hole is formed on a bush which, in turn, is fitted on the inner ring of one or more bearings.

Constructively, the screw is inserted in one or more female screws, the axis of said female screws being parallel, but not coinciding with the axis of the screw: in such a way the contact between the thread of the screw and the thread of each of the female screws is realised, approximately at the generating line of the respective cylindrical surfaces; this can also be realised when the female screws are not coaxial to each other.

Kinematically, by making the screw rotate a corresponding rotation of the female screws in the bearings is also caused, by sliding, not prevented by antagonistic friction forces.

To be specific, each turn of the screw corresponds to a rotation of the female screws by a value smaller than a complete turn thereof; in particular, the axial advance of the screw in the sleeve is equal to the pitch of the thread multiplied by the difference between the number of turns completed by the screw and the number of turns completed by the female screw.

From the operative point of view, since the relative rotation axis between the screw and each of the female screws approximately coincides with the line of the points of contact between the two threads, the resulting friction torque is of reduced value, whereas, consequently, the yield is high; by taking the advance per turn of the screw to minimal values the yield also decreases up to the condition of irreversibility of the screw.

In the practical embodiment, the command is carried out through the use of a motor reducer with low transmission ratio, therefore reversible and, in situations of failure or lack of energy, even able to be actuated manually.

Finally, the finding foresees that the kinematism described above is completed with a mechanism that takes care of locking the rotation of the female screw in the sleeve, in the constructive solution with a rotating screw or the screw itself, in the solution with a rotating female screw, so as to take the aforementioned mechanism back to the operation similar to that of a normal sliding screw, with advance equal to the pitch of the thread; this allows it to be used for rapid movements in the absence of load.

The finding shall be better understood through the description of a possible embodiment thereof, given only as a non-limiting example, with the help of the attached tables of drawings, where:

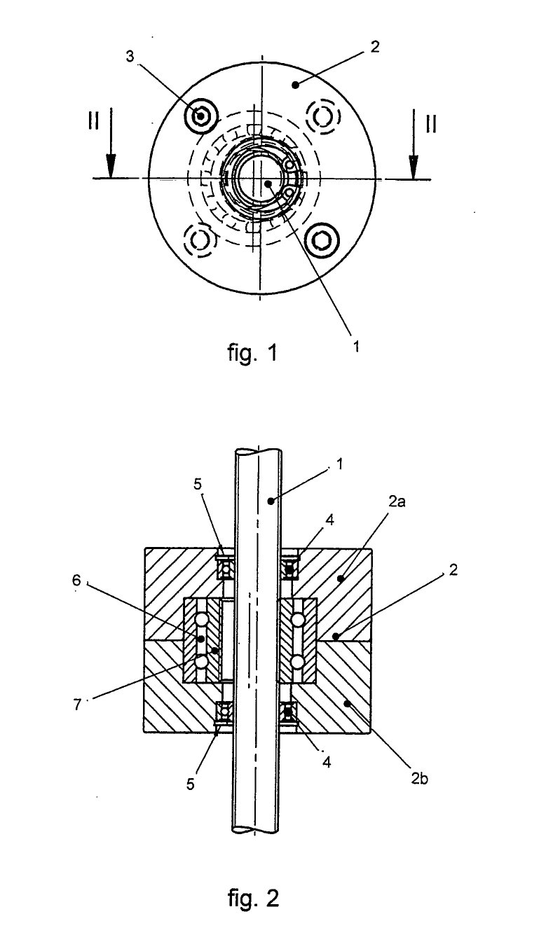

FIGS. 1 and 2 (Table I) respectively represent a plan view and a front elevated view, sectioned according to the line II-II, of an embodiment of the device according to the finding;

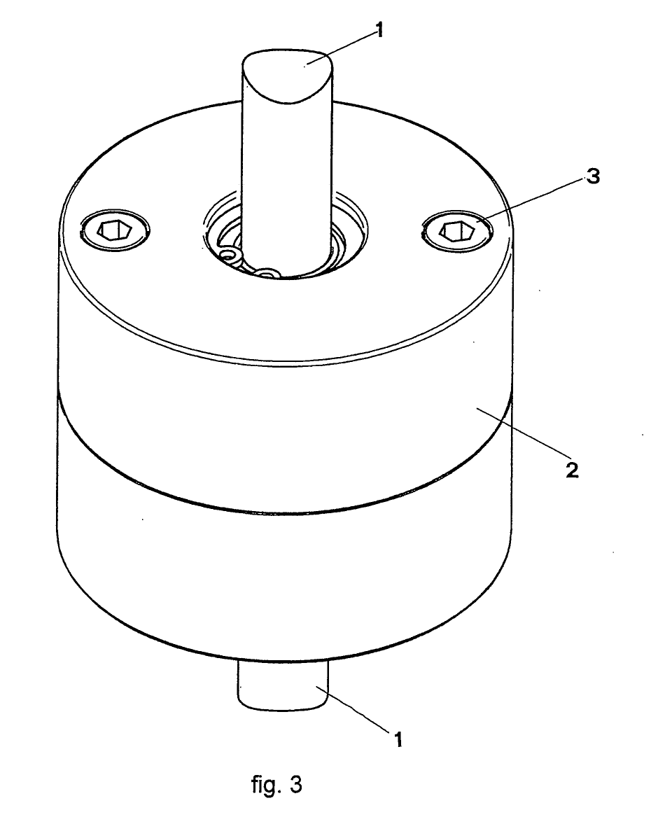

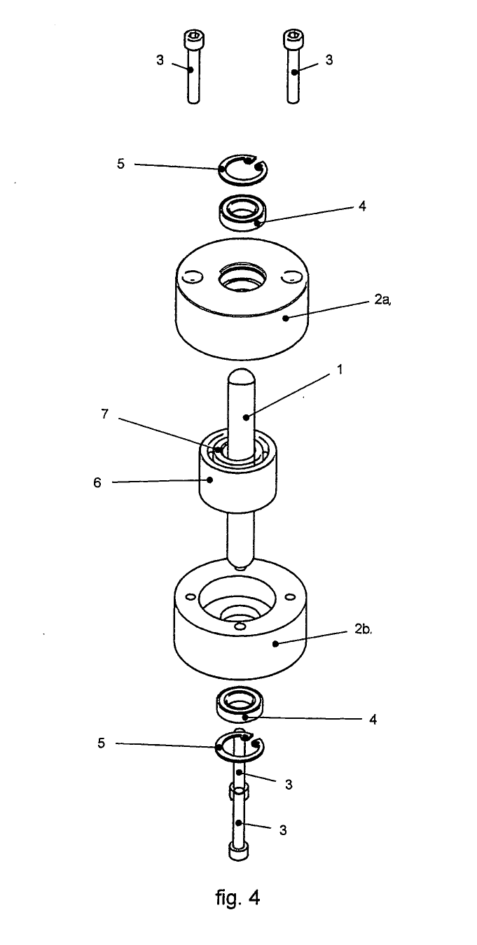

FIG. 3 (Table II) represents a perspective view of the device according to the finding;

FIG. 4 (Table III) represents an exploded view of the device according to FIG. 3;

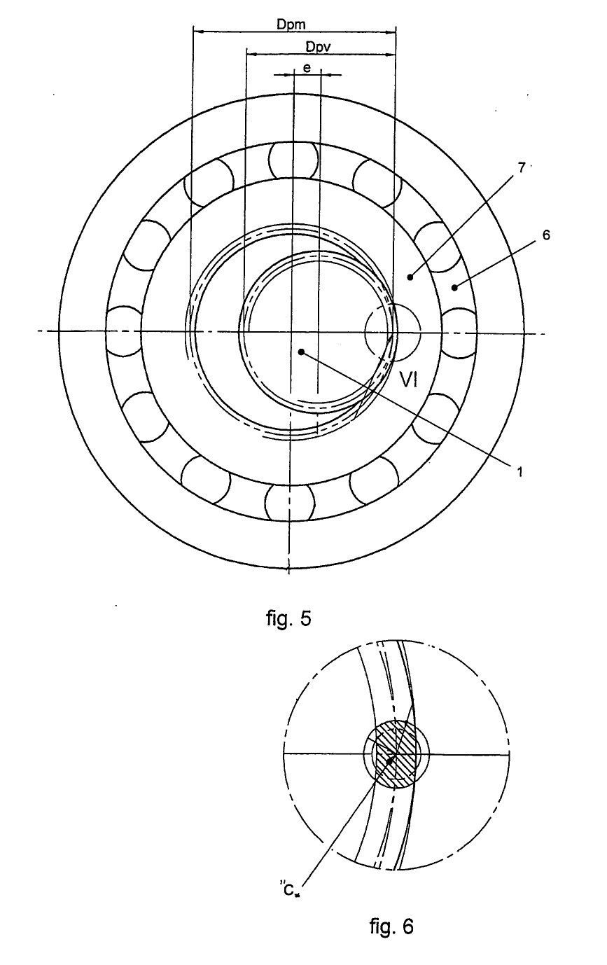

FIGS. 5 and 6 (Table IV) schematically represent a plan view and a detailed view, respectively, of the device according to the finding;

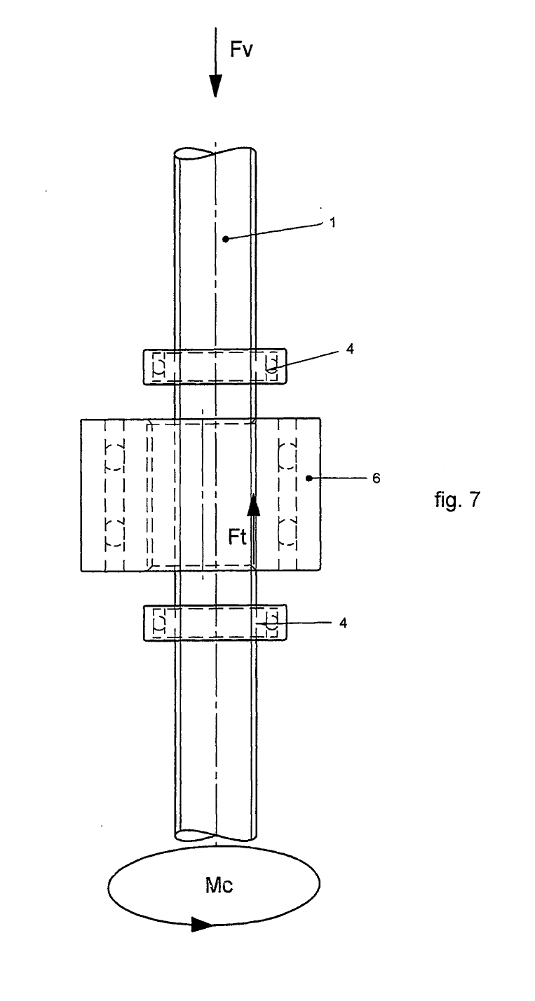

FIG. 7 (Table V) represents a kinematic diagram of the device according to the finding.

As can be seen, in particular in FIGS. 1 and 2, the screw 1 is inserted inside the sleeve 2, made up of two half-shells 2a and 2b, kept joined together through the screws 3.

In the sleeve 2, near to the two bases, the guide bearings 4 are inserted, kept locked by the elastic rings 5.

In the central zone of the sleeve 2 a bearing 6, of the type suitable for bearing axial loads, is mounted, which has its inner ring 7 with a threaded hole.

As can be seen, in particular, in FIGS. 1, 2 and 5, the bearing 6, with a threaded hole, is mounted eccentrically with respect to the axis of the screw 1 (value “e” of FIG. 5) and the axis of the two bearings 4, for guiding the screw itself.

In such a way, as can be seen in FIG. 6, the threads of the screw 1 and the threads of the female screw, formed on the inner ring 7, come into contact with each other approximately along a generatrix of the threaded surface and not on the whole surface.

Operatively, by making the screw 1 rotate about its axis, the threaded inner ring 7 of the central bearing 6 is also forced to rotate in the same direction as that of the aforementioned screw.

As can be seen in FIGS. 5, 6 and 7, the mutual rotation axis between the screw 1 and the threaded ring 7 coincides with the line of contact (see point “C”) of the two ideal cylinders, one with a smaller pitch diameter “Dpv” referring to the screw and the other with a greater pitch diameter “Dpm” referring to the female screw, said two cylinders mutually rotating, without generating a sliding condition and where the aforementioned pitch diameters “Dpv” and “Dpm” are in an intermediate position between the diameter of the crest and the diameter of the base of the threads of the two matching elements, the screw and the female screw.

From observation of the figures and keeping in mind the embodiment described above it can be seen that, in the rotation step, the peripheral speed on the pitch diameter is identical for the screw and the female screw, whereas, due to the difference in diameter, the angular speed of the screw is greater with respect to the angular speed of the female screw; all of this means that one turn of the screw corresponds to less than one complete angular rotation of the female screw equal to an angle given by the formula:
α=Dpv/Dpm·360°
where:
Dpv=pitch rolling diameter of the screw;
Dpm=pitch rolling diameter of the female screw;

Practically, in the two extreme operating conditions, if the screw is in the rotation step and the female screw is, at the same time, in the stop step, the advance of the screw for every turn thereof shall be equal to the pitch of the thread whereas, vice-versa, if the female screw and the screw, at the same time, carry out the same number of turns, there would be no relative movement and therefore the advance of the screw itself shall be zeroed.

In normal operation conditions of the device according to the finding the advance of the screw for every turn thereof is given by the formula:
a=p·(1−Dpv/Dpm)
where:
p=pitch of the threading;

In practice, the closer the ratio between the two diameters is to 1, the lesser the advance of the screw for every complete turn thereof.

Again in normal operating conditions, the yield of the device according to the finding depends upon the friction that is generated and precisely upon:
sliding friction that is present in the contact zone between the threads of the screw and of the female screw;
rolling friction of the bearings of negligible value.

In the condition of normal application of the device according to the finding, ascribable to a lifting action of a load (see FIG. 7) one operates according to the formula:
Ft=Fv+Fag
where:
Ft=load on the threads;
Fv=external load;
Fag sliding friction, having the same direction, but opposite orientation with respect to the advance of the screw, present between the screw and the wall of the hole of the guide bearings and of a value, with greased surfaces, in the order of 0.15 Fv.

Again in the condition of normal application of the device according to the finding, the friction torque present between the threads in mutual rotation is given by the formula:
Maf=Ft·Ra·μ
where:
Ra=radius of the friction force, of a value substantially equal to the pitch “p” of the thread;
μ=friction coefficient between the threads of the screw, of a value of about 0.10;

In the practical act, therefore, the moment to be applied to the screw 1 to cause it to advance is given by the formula:
Mc=Ft·a/(2π)+Maf=Ft·a/(2μ)+Ft·p·μ
where, replacing the numerical values, it is:
Mc=1.15·Fv·[a/(2μ)+0.10·p]=1.15·Fv·[0.16·a+0.10·p]

As can be seen from the last formula, since the advance value is less than the value of the pitch, the friction can reach values that give the irreversibility of the system, and the torque value necessary for lifting the load is very low, due to the low advance value for every turn of the screw.

Finally, the load capacity and the correct operation of the device according to the finding is dependent upon numerous operative factors such as the number of threads in contact, the load capacity of the single or plurality of bearings that support the female screw and the presence of radial flexing loads of the screw, generated by the type of threading and by the eccentricity between the direction of reaction Ft of the threads with respect to the direction of the load Fv of the screw.

Within the general operating principle described above, the constructive solution for a practical embodiment of the rolling screw according to the finding can be of the most varying types; for example it is possible to foresee:
that the screw 1 is idle whereas the threaded ring 7, applied to the female screw is placed in rotation through a transmission system, which uses per se known means, such as belts and gears;
that the screw 1 is fixed, whereas the entire sleeve 2 is placed in rotation through a transmission system, which uses per se known means, such as belts and gears;
the use of two or more female screws contained inside the sleeve itself;
the absence of guide bearings inside the sleeve;
that the female screws consist of internally threaded bushes fitted in the hole of at least one of the sliding or rolling bearings contained in the sleeve;
that the screw and the female screw are equipped with synchronised movement, realised with any type of per se known synchronisation device;
that a preload is applied on the screw to realise an extremely precise movement and positioning of the rotating members to zero the tolerance clearance;
the application of a locking/unlocking system of the rotation of the bearing or of the bearings of the female screw to obtain, when the aforementioned bearings are locked, an advance per turn of the screw equal to the value of the pitch of its thread;
the application of a locking/unlocking system of the rotation of the screw to obtain, when it is locked, an advance per turn of the sleeve of a value equal to the pitch of the thread of the aforementioned screw;
the use of a “free-wheel” type device, which prevents the rotation of the bearing of the female screw in one of the two directions;
the use of a “free-wheel” type device, which prevents the rotation of the screw in one of the two directions;
a plurality of female screws that have diameters of different values;
that the female screws are susceptible to being placed in a condition not in contact with the screw, independently from each other;
that from the plurality of female screws, with different diameters, only a selected one can remain in contact with the screw, so as to obtain an advance per turn of the screw dependent upon the diameter of the specific female screw being used;
that the diameters of each of the female screws have a value such that when all of the aforementioned female screws are in the condition of detachment from the screw it is possible to make the screw slide freely on the guide bearings;
that the female screw is equipped with circumferential throats having the same pitch as the threading and with advance per turn equal to the value of the pitch of the thread of the screw;
that the screw is equipped with circumferential throats and with advance per turn equal to the threading of the female screw;
that one or more female screws are replaced with externally threaded bearings, said bearings being able to be placed in contact with the screw, to obtain advances per turn of a greater value with respect to the pitch of the threading of the screw itself.

1. ROLLING SCREW WITH SMALLER ADVANCE PER TURN THAN THE PITCH OF THE THREADING, characterised in that a threaded coupling is foreseen in which a screw is turned inside one or more female screws (inserted in a single body or sleeve) and where the pitch of the thread of said female screws is equal to that of the screw whereas the nominal diameter is greater than that of the screw itself, each of the female screws consisting of a bearing, able to simultaneously bear both radial and axial loads, with an inner ring that has the threaded hole and where the axis of said female screws is parallel, but not coinciding, with the axis of the screw; in such a way, the contact between the thread of the screw and the thread of each of the female screws is realised, approximately at the generating line of the respective cylindrical surfaces.

2. ROLLING SCREW, according to claim 1, characterised in that the threaded inner hole of the female screw is formed on a bush which, in turn, is fitted onto the inner ring of at least one bearing.

3. ROLLING SCREW, according to claims 1 and 2, characterised in that the female screws are not arranged coaxial to each other.

4. ROLLING SCREW, according to claim 1, characterised in that the screw (1) is inserted inside the sleeve (2), made up of two half-shells (2a, 2b), kept joined together through mobile connection members (3) in the sleeve (2), near to the two bases, with the guide bearings (4) being inserted, kept locked by the elastic rings (5); the screw itself is inserted (but free to slide) on said bearings and in the central zone of the sleeve (2) a bearing (6) is mounted, of the type suitable for bearing axial loads, which has its inner ring (7) with a threaded hole coupled with the screw itself, said bearing (6), with a threaded hole, being mounted eccentrically with respect to the axis of the screw (1) and with respect to the axis of the two guide bearings (4) of the screw itself, with it being foreseen that the threads of the screw (1) and the threads of the female screw, formed on the inner ring (7), come into contact with each other approximately along a generatrix of the threaded surface and not on the whole surface of the thread itself, with the rotation of the screw (1) about its own axis, the threaded inner ring (7) of the central bearing (6) also being made to rotate in the same direction as that of the aforementioned screw.

5. ROLLING SCREW, according to one or more of the previous claims, characterised in that the screw (1) is idle, whereas the threaded ring (7), applied to the female screw, is placed in rotation through a transmission system, which uses per se known means, such as belts and gears.

6. ROLLING SCREW, according to one or more of the previous claims, characterised in that the screw (1) is fixed, whereas the entire sleeve (2) is placed in rotation, through a transmission system, which uses per se known means, such as belts and gears.

7. ROLLING SCREW, according to one or more of the previous claims, characterised in that the use of two or more female screws contained inside the sleeve itself is foreseen.

8. ROLLING SCREW, according to one or more of the previous claims, characterised in that it is foreseen for there to be an absence of guide bearings inside the sleeve.

9. ROLLING SCREW, according to one or more of the previous claims, characterised in that it is foreseen that the female screws consist of internally threaded bushes fitted in the hole of at least one of the sliding or rolling bearings contained in the sleeve.

10. ROLLING SCREW, according to one or more of the previous claims, characterised in that it is foreseen that the screw and the female screw are equipped with synchronised movement, realised with any type of per se known synchronisation device.

11. ROLLING SCREW, according to one or more of the previous claims, characterised in that it is foreseen that a preload is applied on the screw, to realise an extremely precise movement and positioning of the rotating members to zero the tolerance clearance.

12. ROLLING SCREW, according to one or more of the previous claims, characterised in that it foresees the application of a locking/unlocking system of the rotation of the bearing or of the bearings of the female screw to obtain, when the aforementioned bearings are locked, an advance per turn of the screw equal to the value of the pitch of its thread.

13. ROLLING SCREW, according to one or more of the previous claims, characterised in that it foresees the application of a locking/unlocking system of the rotation of the screw to obtain, when it is locked, an advance per turn of the sleeve of a value equal to the pitch of the thread of the aforementioned screw.

14. ROLLING SCREW, according to one or more of the previous claims, characterised in that it foresees the use of a “free-wheel” type device, which prevents the rotation of the bearing of the female screw in one of the two directions.

15. ROLLING SCREW, according to one or more of the previous claims, characterised in that it foresees the use of a “free-wheel” type device, which prevents the rotation of the screw in one of the two directions.

16. ROLLING SCREW, according to one or more of the previous claims, characterised in that it foresees a plurality of female screws that have diameters of different values.

17. ROLLING SCREW, according to one or more of the previous claims, characterised in that it foresees that the female screws are susceptible to being placed in a condition not in contact with the screw, independently from each other.

18. ROLLING SCREW, according to one or more of the previous claims, characterised in that it foresees that from the plurality of female screws, with different diameters, only a selected one can remain in contact with the screw, so as to obtain an advance per turn of the screw dependent upon the diameter of the specific female screw being used.

19. ROLLING SCREW, according to one or more of the previous claims, characterised in that it foresees that the diameters of each of the female screws have a value such that when all of the aforementioned female screws are in the condition of detachment from the screw it is possible to make the screw slide freely on the guide bearings.

20. ROLLING SCREW, according to one or more of the previous claims, characterised in that it foresees that the female screw is equipped with circumferential throats and with advance per turn equal to the threading value of the screw.

21. ROLLING SCREW, according to one or more of the previous claims, characterised in that it foresees that the screw is equipped with circumferential throats and with advance per turn equal to the threading pitch of the female screw.

22. ROLLING SCREW, according to one or more of the previous claims, characterised in that it foresees that one or more female screws are replaced with externally threaded bearings.

23. ROLLING SCREW, according to claim 22, characterised in that it foresees that the externally threaded bearings are placed in contact with the screw, to obtain advances per turn of a greater value with respect to the pitch of the threading of the screw itself.

24. ROLLING SCREW, according to one or more of the previous claims, characterised in that it is actuated through the use of a motor reducer with low transmission ratio, therefore reversible and, in situations of failure or lack of energy, even able to be actuated manually.
